(19) United States
(12) Patent Application Publication
(10) Pub. No.: US 2020/0134604 A1
(43) Pub. Date: Apr. 30, 2020

(54) CREDIT CARD WITH SELECTABLE DEBIT-STYLE FUNCTIONALITY

(71) Applicant: Zero Financial, Inc., San Francisco, CA (US)

(72) Inventors: Joel Washington, San Francisco, CA (US); Bryce Galen, San Francisco, CA (US)

(21) Appl. No.: 16/657,448

(22) Filed: Oct. 18, 2019

Related U.S. Application Data
(60) Provisional application No. 62/752,078, filed on Oct. 29, 2018.

(51) Int. Cl. G06Q 20/34; G07F 7/02; G07F 7/10; G06Q 20/32; G07F 7/08; G06Q 30/02

(52) U.S. Cl. CPC G06Q 20/341; G07F 7/025; G06Q 30/0227; G06Q 20/32; G07F 7/0886; G07F 7/1008

(57) ABSTRACT

Disclosed and described herein are systems and methods that bring together credit card and debit card technologies into a single, streamlined process that automates financial management utilizing software executing (e.g., an “app”) on a portable electronic device such as a smartphone and the like.

### CROSS-REFERENCE TO RELATED APPLICATION

This application claims priority to and benefit of U.S. Provisional Patent Application Ser. No. 62/752,078 filed Oct. 29, 2018, which is fully incorporated by reference and made a part hereof.

### FIELD OF THE INVENTION

Embodiments described herein relate generally to automated systems and methods of financial account management that combines selectable debit-style functionality with credit card rewards.

### BACKGROUND

While debit cards provide balance oversight, due to a complex set of regulations, banks are typically unable to provide any meaningful rewards associated with debit card spending. Rewards primarily stem from merchant processing costs that are paid to the card-issuing bank every time a user uses their card. Credit cards can provide rewards because the processing costs banks receive are much higher than with debit cards.

Credit cards (at least the typical ones) can entice a user with rewards, but require paying a monthly bill and tracking spending in more than one place. This means they're harder to keep up with and can thus entice a user to spend with less oversight and discretion. Even if a user has financial discipline and always pay off their balance in full, when the user uses a credit card, statistically speaking, the user may be more likely to overspend and potentially even end up in unintentional debt in the future.

With credit cards, the negatives associated with likeliness to overspend and potential interest charges often outpace the benefits of any potential rewards a user may receive. Therefore, systems and methods are desired that allow a user to earn credit card rewards while also providing the balance oversight and simplicity that is available with debit cards.

### BRIEF SUMMARY

Disclosed and described herein are systems and methods that bring together credit card and debit card technologies into a single, streamlined process that automates financial management utilizing software executing (e.g., an “app”) on a portable electronic device such as a smartphone and the like.

A software application (“app”) operating on a mobile device (e.g., a smartphone) is utilized to manage the financial accounts with a “credit card” available in varying levels with varying rewards including a percentage of purchases (e.g., up to 3.0%) cash back. The credit card may take on all known forms of a credit card including a physical card or an electronic device (e.g., smartphone) associated with an account, or a uniquely-identified fob or RFID device, or combinations thereof. Generally, the financial account system includes the aforementioned app, a credit card, and an account (e.g., a checking account). The account holds a user's money (which may or may not draw interest and/or be associated with rewards) and a credit card that makes rewards possible. The app has several selectable features referred to herein as the “Debit-style Experience”, that allow the accounts to work together with a user experience comparable to a cash back debit card. When one or more of the debit-style features are selectably enabled through the app, deposits and spending appear in one place in the app and the user receives cash back on spending and rewards competitive with high-yield checking account rates. Debit-style features may also be selectably disabled using the app.

In one aspect, a method of financial account management that combines selectable debit-style functionality with credit card rewards is disclosed. One embodiment of the method comprises providing a software application executing at least in part on a processor of a portable electronic device having a display screen, wherein the software application has a user interface that displays on the display screen and wherein the software application is associated with a credit card account and the credit card account is further associated with a checking account. The credit card account has a credit limit and is configured to receive rewards, wherein the rewards decrease any credit usage of the credit card account and/or increase the credit limit of the credit card account. The method further comprises displaying on the user interface a current position of the credit card account, wherein the current position indicates in real-time the credit availability of the credit card account, said credit availability comprising the credit limit of the credit card account less any credit usage plus any received rewards; displaying on the user interface any recent transactions associated with the credit card account, wherein said recent transactions may comprise any credit usage made using the credit card account where such credit usage reduces the current position of the credit card account and said recent transactions may also comprise any rewards received by the credit card account and any payments or cash withdrawals to the credit card account; providing, for the credit card account, a spending safeguard option, wherein the spending safeguard option can be turned on or off using the software application, wherein when on said spending safeguard option declines credit card purchases that would cumulatively exceed a checking balance in the associated checking account (i.e. purchases that would cause the Current Position to drop below $0); providing, for the credit card account, a cash from automatic teller machines (ATMs) feature that allows cash advances from ATMs where the cash advance is autopaid to the credit card account from the associated checking account right away with no fees to give the experience of a debit card; and providing an Autopay and Cash Back/Rewards option that can be turned on or off using the software application, wherein when on the Autopay and Cash Back/Rewards option requires payment of a credit card account balance in full from the associated checking account as precondition of earning rewards, and giving customers the option to ensure the earning those rewards by autopaying their statement balance (as long as the autopay goes through).

In some instances, the rewards comprise 1% or greater cash back on purchases made using the credit card account.

In instances when the spending safeguard is on, ACH Transfers, wire transfers, or ATM Cash Advances initiated from within the software application that would cause the Current Position to drop below $0 are not allowed to be initiated by the software application, and ACH Transfers, wire transfers, or ATM Cash Advances initiated from elsewhere that would cause a user's Current Position to drop below $0 are declined.

In some instances, the credit card account has an associated physical credit card with security features that is used for making purchases. Optionally or alternatively, the portable electronic device may be used for making purchases on the credit card account.

Also described and disclosed herein are systems for implementing the above-described methods.

Other objects and advantages will become apparent to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 illustrates an exemplary computer or computing device that may comprise all or a portion of aspects of embodiments of the invention.

FIG. 2 is a schematic block diagram of one exemplary handheld electronic device mobile station (portable electronic device) capable of operating in accordance with an embodiment of the present invention.

FIG. 3 is an illustration of an exemplary handheld electronic device mobile station (portable electronic device) with a user interface displaying a current position of the credit card account, wherein the current position indicates in real-time the credit availability of the credit card account, said credit availability comprising the credit limit of the credit card account less any credit usage plus any received rewards; and displaying on the user interface any recent transactions associated with the credit card account, wherein said recent transactions may comprise any credit usage made using the credit card account where such credit usage reduces the current position of the credit card account and said recent transactions may also comprise any rewards received by the credit card account.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes- from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present methods and systems may be understood more readily by reference to the following detailed description of preferred embodiments and the Examples included therein and to the Figures and their previous and following description.

The credit card described herein processes on credit card networks. However, the user experience presented by the app provides the simplicity of a debit card, where a user's deposits and spending appear in one place. The app displays purchases made using the card, along with other deposits and withdrawals, in one place with a real-time net balance (i.e., a “Current Position”) in the app, along with other features. The credit card provides unlimited cash back rewards with no category restrictions at a higher rate than many other credit cards in the U.S. market. Furthermore, there may be no annual, maintenance, or foreign transaction fees. The app also allows a user to track card spending alongside deposits in an account, providing a user experience very similar to those desired from a conventional cash back debit card, as well as rewards competitive with high-yield checking account rates.

In one embodiment, there may be various “levels” of cards. In some instances, these levels are determined by annual spending requirements. A high annual spending requirement goes hand in hand with the aspirational appeal of higher card levels However, higher annual spending may not be the only way to level up to a higher-level card. Users may be able to level up and maintain status by referring others to become users of the disclosed systems and methods.

The disclosed systems and methods allow a higher cash-back reward than conventional credit cards. This is because of a lower cost structure through reduced overhead and a mobile-centric, referral-based approach to acquiring new customers.

Once rewards become eligible for redemption, they may be redeemed at any time using the app.

Because it is a credit card, a billing statement is generated each month, but the statement may be automatically paid if the user agrees to the terms of the Debit-style Experience, which include automatic payments in full.

As with any credit card or loan product, proper use of credit may reflect positively on a user's credit history. This includes managing balances and making payments on time. Because the disclosed systems and methods discourage overspending and encourages automatic payments of card balance, especially with the Debit-style Experience turned on, proper use of the disclosed systems and methods may increase a user's credit score.

However, as with any credit card, late or missed payments may decrease a user's credit score.

The systems and method do not require maintaining its own bank charter, which allows operation with greater efficiency. Banking services, including FDIC insurance on deposits, are provided via partner banks. Because a bank charter required to issue credit cards, the credit card is issued by a partner bank and is usable anywhere a conventional credit card (e.g., MasterCard) is accepted. The deposit account associated with the disclosed systems and method is federally insured, for example up to $250,000 by an FDIC-member partner bank.

In one aspect, a user can send paper checks directly from the app (coming soon).

Generally, cash back only applies to card purchases made using a user's credit care and does not apply to non-card purchase transactions (e.g. ACH, Send a Check, or ATM transactions). Also, transfers, checks, ATM, or other non-card purchase transactions generally do not count towards getting a higher-level card. Only card purchases made using the credit card count towards leveling up to a higher-level card.

A person enrolling in the disclosed systems and methods will need to provide their full legal name, U.S. physical address, date of birth, tax identification number (e.g., social security number), phone number, email address, and a copy of government-issued photo identification. The application may also require the applicant to provide annual income, satisfy certain underwriting criteria, and pass a credit check.

Generally, a user will not be held responsible for unauthorized transactions if the user uses reasonable care in protecting their card from loss or theft; and the user promptly reports the loss or theft.

Additional features may include rewards (e.g., earn 1.0% to 3.0% cash back on spending and additional rewards of 0% to 1.75% annually on average Current Position (if the user uses the account associated with the disclosed systems and methods). With the associated account, a user can receive direct deposits, send and receive ACH transfers, deposit checks by taking a photo, and send paper checks directly from the app. With the disclosed system, a user does not pay any ATM fees beyond what the ATM owner may charge, and at the certain card levels, all ATM fees including what the ATM owner may charge may be refunded to the user. As noted herein, the disclosed systems are compatible with electronic “credit card” mobile payment systems such as Apple Wallet. Generally, the disclosed systems and methods avoid most annoying fees of typical bank accounts such as maintenance, bill pay, inactivity, foreign currency, annual, or add-on ATM fees.

Obtaining the disclosed credit card generally requires downloading the app from an app store such as the Apple App Store, completing a credit application, and receiving approval. Approval may be based on a variety of factors such as, for example, being a legal resident of the United States, at least 18 years old (19 if you live in Alabama or if you're a ward of the state in Nebraska), and having a valid social security number. Currently, a user may need a physical address in the United States. An applicant may also be required to satisfy certain underwriting criteria and pass a credit check.

As described herein, there may be different card levels. For example, there may be four levels, which may vary in terms of the cash back rate they earn. For example, an entry-level card (e.g., Zerocard Quartz) may earn 1.0% cash back, intermediate level cards (e.g. Zerocard Graphite or Zerocard Magnesium) may earn 1.5% and 2.0%, respectively, and a highest-level card (e.g., Zerocard Carbon) may earn 3.0% cash back. Leveling up to a higher-level card allows a user to earn more cash back on purchases at a greater rate. There may be requirements for earning the full cash back amount. For example, Zerocard Graphite, Magnesium, and Carbon may require that the user's statement balance is paid in full, on time, from the associated account each month. Enabling the Debit-style Experience in the app helps ensure that this happens. Please refer to the Zero app and Zerocard Agreement for more details.

In other aspects, a user may level up to a higher-level card by successfully inviting others to sign up for the disclosed systems and methods. For example, a user inviting a defined number of others (e.g., referring 1, 2, or 4 friends to become a user) allows a user level up to Zerocard Graphite, Zerocard Magnesium, or Zerocard Carbon, respectively. A user may also qualify for a higher-level card by spending. To level up via spending by spending, for example, $25,000, $50,000, or $100,000 for Zerocard Graphite, Zerocard Magnesium, or Zerocard Carbon, respectively. Generally, users that level up will maintain higher level status for the remainder of the calendar year in which they level up, plus all of the following calendar year. Generally, higher level card status must be re-earned each calendar year before the level is set to expire. Users enjoy the benefits of higher level card status from the day that it is earned through the end of the following calendar year, subject to the terms and conditions outlined in a user's agreement.

The disclosed systems and methods support iOS, Android and other platforms.

The debit-style experience disclosed herein enables one or more features through the app that allows the associated account and the credit card to work together like a checking account with a cash back debit card. Additional information about these debit-style features can be found in Appendix A, which is fully incorporated by reference and made a part hereof. These debit-style features may include:

1. Current Position—displaying a checking account balance minus an associated credit card account balance including pending transactions and authorizations, to provide a real-time snapshot of someone's day-to-day financial standing. Generally, this is displayed in the main screen in the Zero app to provide users real-time oversight into their spending ability (similar to a debit card and checking account).

2. Spending Safeguard - declining credit card purchases that would cumulatively exceed the checking balance in an associated account (i.e. purchases that would cause Current Position to drop below $0). Spending Safeguard is a user setting that, when turned on using the app, affects the functionality of a customer's card and associated accounts. It is a component of Opting into Debit-style Experience and can only be turned on by enabling Opting into Debit-style Experience through the app. The purpose of Spending Safeguard is to allow the two traditional financial products, a credit card and a DDA, to work together “under the hood” to simulate the user experience of a debit card (with the added benefit of Rewards Posting that would not be possible with an actual debit card). When Spending Safeguard is on, it has the following impacts on the user's card: Card purchases that would cause a user's Current Position to drop below $0 are declined. When Spending Safeguard is on, it has the following impacts on the associated accounts: (1.) ACH Transfers, wire transfers, or ATM Cash Advances initiated from within the app that would cause a user's Current Position to drop below $0 are not allowed to be initiated (Users get the Spending Safeguard Block); (2.) ACH Transfers, wire transfers, or ATM Cash Advances initiated from elsewhere that would cause a user's Current Position to drop below $0 are declined;

3. Cash from ATMs—allowing cash advances from ATMs where the cash advance is autopaid from an associated checking account right away with no fees to give the experience of a debit card. Additional information about this aspect can be found in Appendix B, which is fully incorporated by reference and made a part hereof.

4. Autopay & Cash Back/Rewards - requiring payment of a credit card account balance in full from an associated checking account as precondition of earning rewards beyond 1% cash back, and giving customers the option to ensure the earning those rewards by autopaying their statement balance (as long as the autopay goes through). For example, Debit-style Experience comes with Autopay for the customer may automatically pay the full statement balance 11 days after the statement is generated. As making an on-time payment of the full statement balance from the associated accounts may be required to earn rewards beyond the base percentage (e.g., 1%), this feature helps customers maximize their rewards.

As noted, one or more of these features can be toggled on and off within the app. In various aspects, the associated account can be, for example any type of account including loan account such as a credit or a charge card paired with any type of deposit account such as DDA, NOW, money market or savings account(s).

Computing Environments

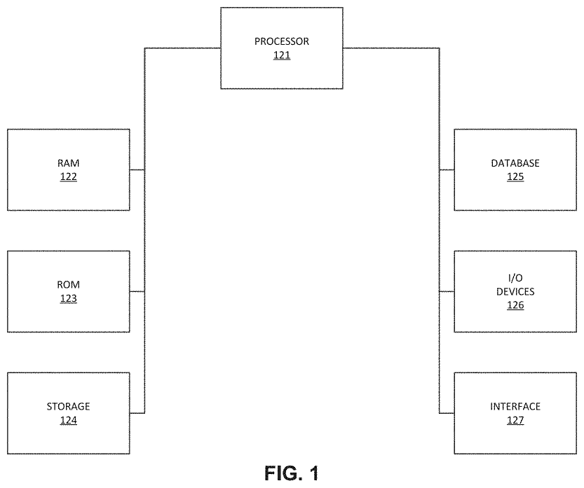

FIG. 1 illustrates an exemplary computer or computing device that can be used for some or all of the features described herein. All or a portion of the device shown in FIG. 1 may comprise all or a portion of any of the components described herein that may include and/or require a processor or processing capabilities including, for example, all or part of a smartphone or other portable electronics capable of executing software that comprised the “app” described herein. The exemplary computer or computing device of FIG. 1 may also comprise all or a portion of a system used to implement the embodiments described herein such as a server configured to communicate with a portable electronic device such as a smartphone and to interface with other systems such as banking network and/or a credit card network. As used herein, “computer” may include a plurality of computers. The computers may include one or more hardware components such as, for example, a processor 121, a random-access memory (RAM) module 122, a read-only memory (ROM) module 123, a storage 124, a database 125, one or more input/output (I/O) devices 126, and an interface 127. Alternatively, and/or additionally, the computer may include one or more software components such as, for example, a computer-readable medium including computer executable instructions for performing a method associated with the exemplary embodiments. It is contemplated that one or more of the hardware components listed above may be implemented using software. For example, storage 124 may include a software partition associated with one or more other hardware components. It is understood that the components listed above are exemplary only and not intended to be limiting.

Processor 121 may include one or more processors, each configured to execute instructions and process data to perform one or more functions associated with a computer for financial account management that combines selectable debit-style functionality with credit card rewards and automated transaction processing. Processor 121 may be communicatively coupled to RAM 122, ROM 123, storage 124, database 125, I/O devices 126, and interface 127. Processor 121 may be configured to execute sequences of computer program instructions to perform various processes. The computer program instructions may be loaded into RAM 122 for execution by processor 121.

RAM 122 and ROM 123 may each include one or more devices for storing information associated with operation of processor 121. For example, ROM 123 may include a memory device configured to access and store information associated with the computer, including information for identifying, initializing, and monitoring the operation of one or more components and subsystems. RAM 122 may include a memory device for storing data associated with one or more operations of processor 121. For example, ROM 123 may load instructions into RAM 122 for execution by processor 121.

Storage 124 may include any type of mass storage device configured to store information that processor 121 may need to perform processes corresponding with the disclosed embodiments. For example, storage 124 may include one or more magnetic and/or optical disk devices, such as hard drives, CD-ROMs, DVD-ROMs, or any other type of mass media device.

Database 125 may include one or more software and/or hardware components that cooperate to store, organize, sort, filter, and/or arrange data used by the computer and/or processor 121. For example, database 125 may store information and instructions related to financial account management that combines selectable debit-style functionality with credit card rewards. It is contemplated that database 125 may store additional and/or different information than that listed above.

I/O devices 126 may include one or more components configured to communicate information with a user associated with computer. For example, I/O devices may include input screens (e.g., virtual keyboards), a touch screen, and/or a console with an integrated keyboard and mouse to allow a user to enable and/or disable debit-style functionality associated with the credit card. I/O devices 126 may also include a display including a graphical user interface (GUI) for outputting information on a monitor and/or a screed of a portable electronic device. I/O devices 126 may also include peripheral devices such as, for example, a printer for printing information associated with the computer, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 127 may include one or more components configured to transmit and receive data via a communication network, such as the Internet, a local area network, a workstation peer-to-peer network, a direct link network, a wireless network, or any other suitable communication platform. For example, interface 127 may include one or more modulators, demodulators, multiplexers, demultiplexers, network communication devices, wireless devices, antennas, modems, and any other type of device configured to enable data communication via a communication network.

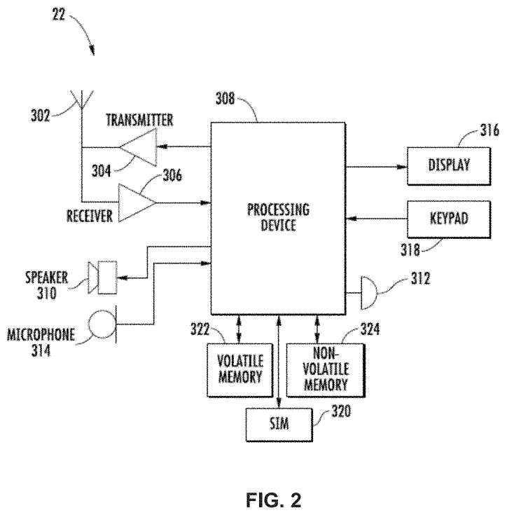

Reference is further made to FIG. 2, which illustrates one type of electronic device that would benefit from embodiments of the present invention. As shown, the electronic device may be a handheld electronic device 22, and, in particular, a cellular telephone. It should be understood, however, that the device illustrated and hereinafter described is merely illustrative of one type of electronic device that would benefit from the present invention and, therefore, should not be taken to limit the scope of the present invention. While several embodiments of the handheld electronic device 22 are illustrated and will be hereinafter described for purposes of example, other types of mobile stations, such as personal digital assistants (PDAs), pagers, laptop computers, as well as other types of electronic systems including both mobile, wireless devices and fixed, wireline devices, can readily employ embodiments of the present invention.

The handheld electronic device 22 includes various means for performing one or more functions in accordance with embodiments of the present invention, including those more particularly shown and described herein. It should be understood, however, that the mobile station may include alternative means for performing one or more like functions, without departing from the spirit and scope of the present invention. More particularly, for example, as shown in FIG. 2, in addition to an antenna 302, the handheld electronic device 22 includes a transmitter 304, a receiver 306, and an apparatus that includes means, such as a processor 308, controller or the like, that provides signals to and receives signals from the transmitter 304 and receiver 306, respectively, and that performs the various other functions described below including, for example, the functions relating to the processes described in relation to the debit-style features.

As one of ordinary skill in the art would recognize, the signals provided to and received from the transmitter 304 and receiver 306, respectively, may include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G, 3G, 4G, 4G LTE communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra-wideband (UWB), and the like

It is understood that the processor 308, controller or other computing device, may include the circuitry required for implementing the video, audio, and logic functions of the mobile station and may be capable of executing application programs for implementing the functionality discussed herein. For example, the processor may be comprised of various means including a digital signal processor device, a microprocessor device, and various analog to digital converters, digital to analog converters, and other support circuits. The control and signal processing functions of the mobile device are allocated between these devices according to their respective capabilities. The processor 308 thus also includes the functionality to convolutionally encode and interleave message and data prior to modulation and transmission. Further, the processor 308 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The handheld electronic device 22 may also comprise means such as a user interface including, for example, a conventional earphone or speaker 310, a ringer 312, a microphone 314, a display 316, all of which are coupled to the processor 308. The user input interface, which allows the mobile device to receive data, can comprise any of a number of devices allowing the mobile device to receive data, such as a keypad 318, a touch display (not shown), a microphone 314, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The handheld electronic device 22 can also include means, such as memory including, for example, a subscriber identity module (SIM) 320, a removable user identity module (R-UIM) (not shown), or the like, which may store information elements related to a mobile subscriber. In addition to the SIM, the mobile device can include other memory. In this regard, the mobile station can include volatile memory 322, as well as other non-volatile memory 324, which can be embedded and/or may be removable. For example, the other non-volatile memory may be embedded or removable multimedia memory cards (MMCs), secure digital (SD) memory cards, Memory Sticks, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs. For example, in one embodiment of the present invention, the memory may store computer program code for performing the processes associated with FIGS. 1A and 1B, as described herein.

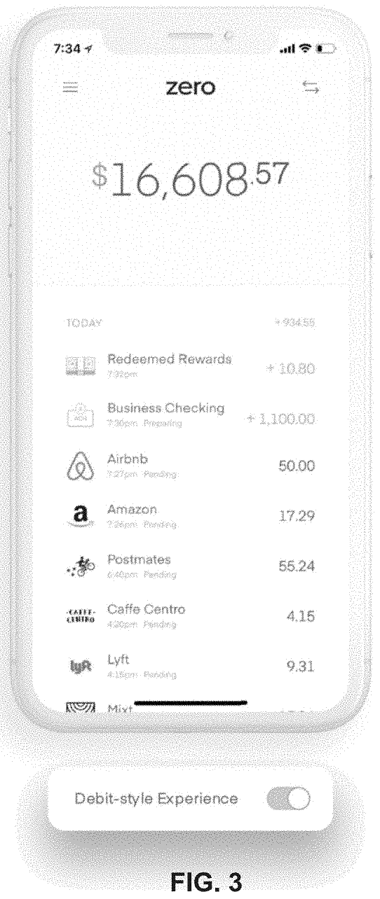

FIG. 3 is an illustration of an exemplary handheld electronic device 22 mobile station (portable electronic device) with a user interface displaying a current position of the credit card account, wherein the current position indicates in real-time the credit availability of the credit card account, said credit availability comprising the credit limit of the credit card account less any credit usage plus any received rewards; and displaying on the user interface any recent transactions associated with the credit card account, wherein said recent transactions may comprise any credit usage made using the credit card account where such credit usage reduces the current position of the credit card account and said recent transactions may also comprise any rewards received by the credit card account.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications may be referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method of financial account management that combines selectable debit-style functionality with credit card rewards, said method comprising:
providing a software application executing at least in part on a processor of a portable electronic device having a display screen, wherein the software application has a user interface that displays on the display screen and wherein the software application is associated with a credit card account, said credit card account further associated with a checking account, said credit card account having a credit limit and configured to receive rewards, wherein said rewards decrease any credit usage of the credit card account and/or increase the credit limit of the credit card account;
displaying on the user interface a current position of the credit card account, wherein the current position indicates in real-time the credit availability of the credit card account, said credit availability comprising the credit limit of the credit card account less any credit usage plus any received rewards;
displaying on the user interface any recent transactions associated with the credit card account, wherein said recent transactions may comprise any credit usage made using the credit card account where such credit usage reduces the current position of the credit card account and said recent transactions may also comprise any rewards received by the credit card account and any payments or cash withdrawals to the credit card account;
providing, for the credit card account, a spending safeguard option, wherein the spending safeguard option can be turned on or off using the software application, wherein when on said spending safeguard option declines credit card purchases that would cumulatively exceed a checking balance in the associated checking account (i.e. purchases that would cause the Current Position to drop below $0);
providing, for the credit card account, a cash from automatic teller machines (ATMs) feature that allows cash advances from ATMs where the cash advance is autopaid to the credit card account from the associated checking account right away with no fees to give the experience of a debit card; and
providing an Autopay and Cash Back/Rewards option that can be turned on or off using the software application, wherein when on the Autopay and Cash Back/Rewards option requires payment of a credit card account balance in full from the associated checking account as precondition of earning rewards, and giving customers the option to ensure the earning those rewards by autopaying their statement balance (as long as the autopay goes through).

2. The method of claim 1, wherein the rewards comprise 1% or greater cash back on purchases made using the credit card account.

3. The method of claim 1, wherein when the spending safeguard is on, ACH Transfers, wire transfers, or ATM Cash Advances initiated from within the software application that would cause the Current Position to drop below $0 are not allowed to be initiated by the software application, and ACH Transfers, wire transfers, or ATM Cash Advances initiated from elsewhere that would cause a user's Current Position to drop below $0 are declined.

4. The method of claim 1, wherein the credit card account has an associated physical credit card with security features that is used for making purchases.

5. The method of claim 1, wherein the portable electronic device is used for making purchases on the credit card account.

6. A system for financial account management that combines selectable debit-style functionality with credit card rewards, said system comprising:
a portable electronic device comprising a processor, a memory in communication with the processor, a display screen, an input-output mechanism, and a communications interface, wherein the portable electronic device is in communication with one or more remote servers using the communications interface, wherein the processor executes computer-executable code stored in the memory, said computer-executable code providing a software application executing on the processor of the portable electronic device, wherein the software application has a user interface that displays on the display screen and wherein the software application is associated, via the remote server, with a credit card account, said credit card account further associated with a checking account, said credit card account having a credit limit and configured to receive rewards, wherein said rewards decrease any credit usage of the credit card account and/or increase the credit limit of the credit card account, wherein the software application causes the processor to:
display on the user interface a current position of the credit card account, wherein the current position indicates in real-time the credit availability of the credit card account, said credit availability comprising the credit limit of the credit card account less any credit usage plus any received rewards;
displaying on the user interface any recent transactions associated with the credit card account, wherein said recent transactions may comprise any credit usage made using the credit card account where such credit usage reduces the current position of the credit card account and said recent transactions may also comprise any rewards received by the credit card account and any payments or cash withdrawals to the credit card account;
provide, for the credit card account, a spending safeguard option, wherein the spending safeguard option can be turned on or off using the software application, wherein when on said spending safeguard option declines credit card purchases that would cumulatively exceed a checking balance in the associated checking account (i.e. purchases that would cause the Current Position to drop below $0);
provide, for the credit card account, a cash from automatic teller machines (ATMs) feature that allows cash advances from ATMs where the cash advance is autopaid to the credit card account from the associated checking account right away with no fees to give the experience of a debit card; and
provide an Autopay and Cash Back/Rewards option that can be turned on or off using the software application, wherein when on the Autopay and Cash Back/Rewards option requires payment of a credit card account balance in full from the associated checking account as precondition of earning rewards, and giving customers the option to ensure the earning those rewards by autopaying their statement balance (as long as the autopay goes through).

7. The system of claim 6, wherein the rewards comprise 1% or greater cash back on purchases made using the credit card account.

8. The system of claim 6, wherein when the spending safeguard is on, ACH Transfers, wire transfers, or ATM Cash Advances initiated from within the software application that would cause the Current Position to drop below $0 are not allowed to be initiated by the software application, and ACH Transfers, wire transfers, or ATM Cash Advances initiated from elsewhere that would cause a user's Current Position to drop below $0 are declined.

9. The system of claim 6, wherein the credit card account has an associated physical credit card with security features that is used for making purchases.

10. The system of claim 6, wherein the portable electronic device is used for making purchases on the credit card account.
